(19) United States
(12) Patent Application Publication
(10) Pub. No.: US 2021/0374104 A1
(43) Pub. Date: Dec. 2, 2021

(54) ELECTRONIC APPARATUS, LOG COLLECTION SYSTEM, AND CONTROL METHOD FOR ELECTRONIC APPARATUS

(71) Applicant: SEIKO EPSON CORPORATION, Tokyo (JP)

(72) Inventor: Takayuki SHIMIZU, Matsumoto-shi (JP)

(73) Assignee: SEIKO EPSON CORPORATION, Tokyo (JP)

(21) Appl. No.: 17/334,263

(22) Filed: May 28, 2021

(30) Foreign Application Priority Data
Jun. 1, 2020 (JP) 2020-095321

(51) Int. Cl. G06F 16/17; G06F 16/18

(52) U.S. Cl. CPC G06F 16/1734; G06F 16/1873; G06F 16/1805

(57) ABSTRACT

An electronic apparatus communicable with a server that stores gained log information representing an item of a log to be gained, includes an inquiry unit that transmits an inquiry regarding the gained log information to the server, a receiving unit that receives the gained log information transmitted from the server in response to the inquiry, and a transmission execution unit that operates based on the gained log information, wherein, when the gained log information does not represent a first item, the transmission execution unit does not transmit a first log relevant to the first item of a plurality of logs relevant to the electronic apparatus to the server and, when the gained log information represents the first item, transmits the first log to the server.

The present application is based on, and claims priority from JP Application Serial Number 2020-095321, filed Jun. 1, 2020, the disclosure of which is hereby incorporated by reference herein in its entirety.

### BACKGROUND

### 1. Technical Field

The present disclosure relates to an electronic apparatus, a log collection system, and a control method for an electronic apparatus.

### 2. Related Art

Recently, services to transmit pluralities of logs relevant to electronic apparatuses such as projectors and printers to database apparatuses by the electronic apparatuses and store the pluralities of logs by the database apparatuses have grown popular. For example, JP-A-2010-39876 discloses a log collection system that collects logs generated in a large number, classifies the logs into summary logs and detailed logs based on similarities and presence or absence of results of the logs, and stores the summary logs in a database apparatus.

However, to change a log to be gained of the plurality of logs relevant to the electronic apparatus, it is necessary to change the program of the electronic apparatus. Therefore, it is difficult to change the log to be gained of the plurality of logs relevant to the electronic apparatus.

### SUMMARY

An electronic apparatus according to a preferable aspect of the present disclosure is an electronic apparatus communicable with a server that stores gained log information representing an item of a log to be gained, including an inquiry unit that transmits an inquiry regarding the gained log information to the server, a receiving unit that receives the gained log information transmitted from the server in response to the inquiry, and a transmission execution unit that operates based on the gained log information, wherein, when the gained log information does not represent a first item, the transmission execution unit does not transmit a first log relevant to the first item of a plurality of logs relevant to the electronic apparatus to the server and, when the gained log information represents the first item, transmits the first log to the server.

A log collection system according to a preferable aspect of the present disclosure is a log collection system including a first electronic apparatus, a second electronic apparatus, and a server, wherein the server stores third gained log information representing an item of a log to be gained of a plurality of logs relevant to the first electronic apparatus and fourth gained log information representing an item of a log to be gained of a plurality of logs relevant to the second electronic apparatus, the first electronic apparatus includes a first inquiry unit that transmits a first inquiry regarding the third gained log information to the server, a first receiving unit that receives the third gained log information transmitted from the server in response to the first inquiry, and a first transmission execution unit that operates based on the third gained log information, when the third gained log information does not represent a first item, the first transmission execution unit does not transmit a first log relevant to the first item of the plurality of logs relevant to the first electronic apparatus to the server and, when the third gained log information represents the first item, transmits the first log to the server, the second electronic apparatus includes a second inquiry unit that transmits a second inquiry regarding the fourth gained log information to the server, a second receiving unit that receives the fourth gained log information transmitted from the server in response to the second inquiry, and a second transmission execution unit that operates based on the fourth gained log information, when the fourth gained log information does not represent a second item, the second transmission execution unit does not transmit a second log relevant to the second item of the plurality of logs relevant to the second electronic apparatus to the server and, when the fourth gained log information represents the second item, transmits the second log to the server, and the server includes a gained log information transmitting unit that transmits the third gained log information to the first electronic apparatus when receiving the first inquiry, and transmits the fourth gained log information to the second electronic apparatus when receiving the second inquiry.

A control method according to a preferable aspect of the present disclosure is a control method for an electronic apparatus communicable with a server that stores gained log information representing an item of a log to be gained, the control method including transmitting an inquiry regarding the gained log information to the server, receiving the gained log information transmitted from the server in response to the inquiry, and, when the gained log information does not represent a first item, not transmitting a first log relevant to the first item of a plurality of logs relevant to the electronic apparatus to the server and, when the gained log information represents the first item, transmitting the first log to the server.

### BRIEF DESCRIPTION OF THE DRAWINGS

FIG. 1 is a block diagram showing a configuration of a log collection system.

FIG. 2 shows a configuration of a projector.

FIG. 3 shows a configuration of a server.

FIG. 4 shows a configuration of a database apparatus.

FIG. 5 shows memory contents of relating information.

FIG. 6 shows memory contents of log information.

FIG. 7 shows a configuration of a user terminal.

FIG. 8 shows functions of the log collection system.

FIG. 9 is a sequence diagram showing operations of the log collection system.

FIG. 10 shows memory contents of the log information after execution of processing at step SB14.

FIG. 11 is a block diagram showing a configuration of a log collection system in a second embodiment.

FIG. 12 shows a configuration of a PC.

FIG. 13 shows a configuration of a database apparatus in a third embodiment.

FIG. 14 shows memory contents of relating information.

FIG. 15 shows a configuration of a log collection system in the third embodiment.

FIG. 16 is a sequence diagram showing operations of the log collection system.

FIG. 17 is a sequence diagram showing operations of the log collection system.

FIG. 18 is a sequence diagram showing operations of the log collection system.

FIG. 19 is a sequence diagram showing operations of the log collection system.

FIG. 20 shows memory contents of the log information after execution of processing at step SBb96.

FIG. 21 is a block diagram showing a configuration of a log collection system.

FIG. 22 is a sequence diagram showing operations of the log collection system.

FIG. 23 is a sequence diagram showing operations of the log collection system.

FIG. 24 shows functions of a log collection system in a first modified example.

### DESCRIPTION OF EXEMPLARY EMBODIMENTS

As below, aspects for embodying the present disclosure will be explained with reference to the drawings. In the respective drawings, dimensions and scales of the respective parts are appropriately made different from real ones. Further, the following embodiments are preferable specific examples of the present disclosure and technically preferable various limitations are added, however, the scope of the present disclosure is not limited to these embodiments unless there is description that limits the present disclosure in the following explanation.

### 1. EMBODIMENT

First, a log collection system 1 according to the embodiment will be explained.

### 1.1. Outline of Log Collection System 1

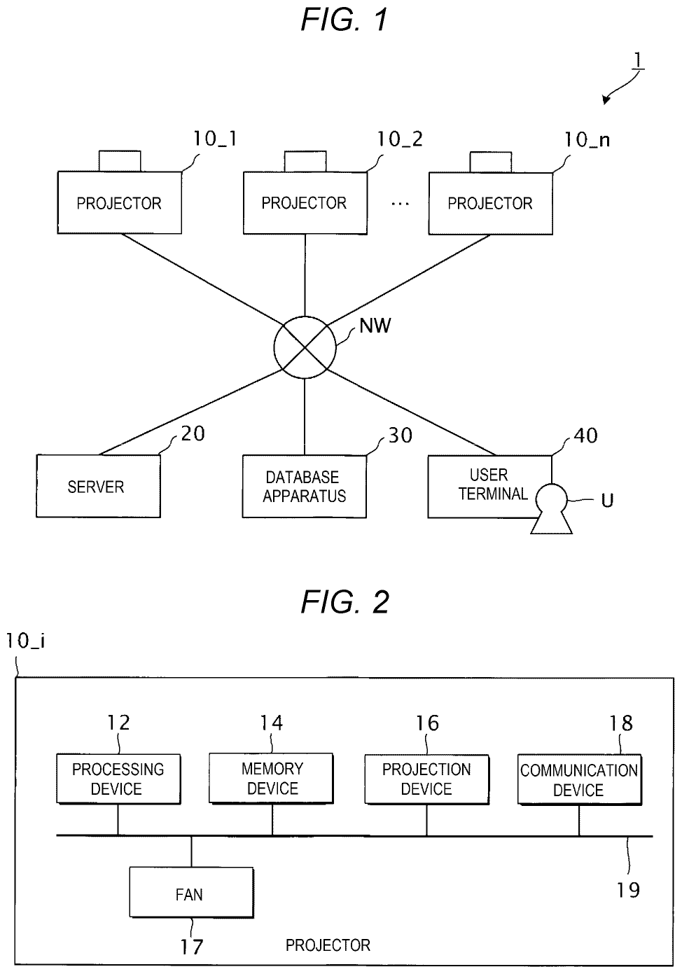

FIG. 1 is a block diagram showing a configuration of the log collection system 1. The log collection system 1 is a system that collects a plurality of logs LG relevant to one or more electronic apparatuses, stores the collected logs LG in a database apparatus 30, and provides the logs LG to a user U. The user U analyzes the collected logs LG. As a result of the analysis, the user U finds out a new challenge and extracts a log LG corresponding to the new challenge of the plurality of logs LG relevant to the electronic apparatus. The log collection system 1 in the first embodiment is a system that the user U may easily change the log LG to be gained of the plurality of logs LG relevant to the electronic apparatus.

The electronic apparatus is e.g. an apparatus that processes one or both of images and sound or an apparatus that digitally processes information. Specifically, the electronic apparatus is a projector, a printer, an electronic timepiece, or the like. One or more electronic apparatuses of the log collection system 1 may be electronic apparatuses of the same type or electronic apparatuses of different types from each other. As below, a projector 10 will be explained as an example of the electronic apparatus.

The plurality of logs LG relevant to the projector 10 are logs indicating records of processing by the projector 10 or logs indicating records of operations by the projector 10 or both. The plurality of logs LG relevant to the projector 10 include e.g. an error code indicating an error occurring during operation of the projector 10, a number of rotations of a fan 17 shown in FIG. 2, a temperature of the projector 10, etc.

The log collection system 1 has a projector 10_1, a projector 10_2, . . . , a projector 10_n, a server 20, the database apparatus 30, and a user terminal 40. n is an integer equal to or larger than 1. The n projectors 10, the server 20, the database apparatus 30, and the user terminal 40 are connected to a communication network NW such as a LAN and the Internet. LAN is an abbreviation for Local Area Network.

In the following explanation, when the elements of the same type are distinguished, reference signs are used like the projector 10_1 and the projector 10_2. On the other hand, when the elements of the same type are not distinguished, only common numbers of the reference signs are used like the projectors 10.

The projector 10 is an apparatus that projects images. One or more projectors 10 are installed in e.g. facilities such as schools or companies.

The server 20 is an apparatus that manages the one or more projectors 10. The database apparatus 30 is an apparatus that stores the logs LG relevant to the projectors 10. For example, the database apparatus 30 may store the logs LG relevant to the projectors 10 according to a relational database or store the logs according to KVS as a management method of data. KVS is an abbreviation for Key Value Store. When a quantity of the logs LG relevant to the projectors 10 is enormous, KVS is more preferable than the relational database.

The user terminal 40 is a terminal operated by the user U. The user U is e.g. a manager who manages the projectors 10 or a developer who develops some service using the plurality of logs LG relevant to the projectors 10. The user U may be a single person or several people.

FIG. 2 shows a configuration of a projector 10_i. i is an arbitrary integer from 1 to n. The projector 10 has a processing device 12, a memory device 14, a projection device 16, the fan 17, and a communication device 18. The respective elements of the projector 10 are coupled to one another by a bus 19 for information communications.

The processing device 12 is a computer such as a CPU. CPU is an abbreviation for Central Processing Unit. Note that the processing device 12 may include one or more processors.

The memory device 14 is a magnetic memory device or a flash ROM. ROM is an abbreviation for Read Only Memory. The memory device 14 is a recording medium readable by the processing device 12, and stores a plurality of programs including a control program executed by the processing device 12, various kinds of information used by the processing device 12, etc.

The projection device 16 has a lens and projects images via the lens. The fan 17 sends air into the projector 10 to cool inside of the projector 10. The communication device 18 is hardware having a communication circuit for communication with another device via the communication network NW.

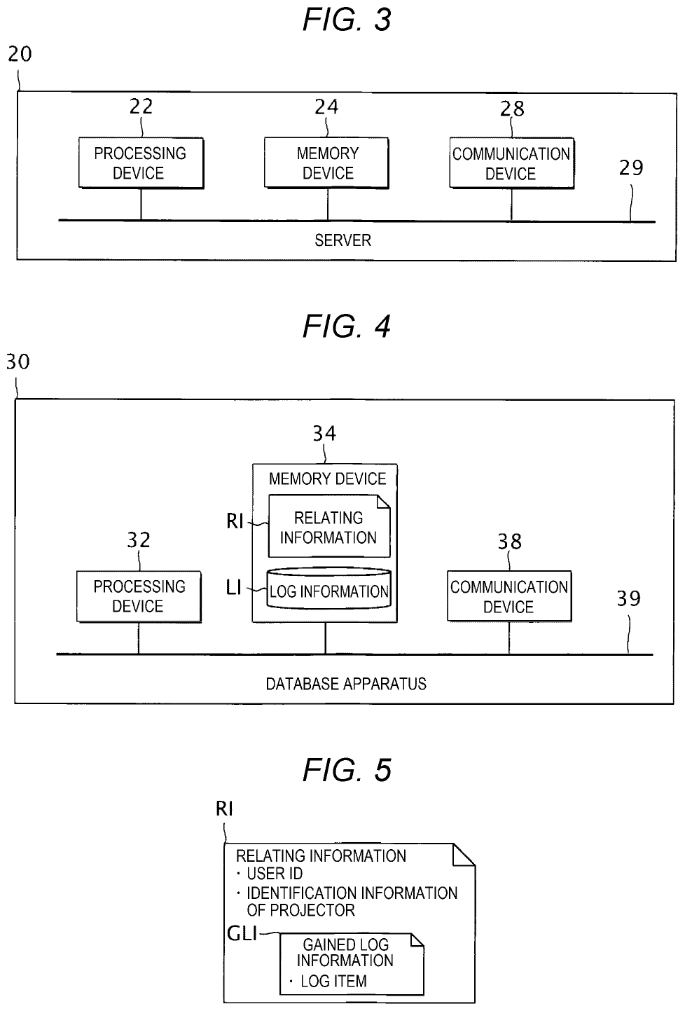

FIG. 3 shows a configuration of the server 20. The server 20 has a processing device 22, a memory device 24, and a communication device 28. The respective elements of the server 20 are coupled to one another by a bus 29 for information communications.

The processing device 22 is a computer such as a CPU. Note that the processing device 22 may include one or more processors.

The memory device 24 is a magnetic memory device or a flash ROM. The memory device 24 is a recording medium readable by the processing device 22, and stores a plurality of programs including a control program executed by the processing device 22, various kinds of information used by the processing device 22, etc.

The communication device 28 is hardware having a communication circuit for communication with another device via the communication network NW.

FIG. 4 shows a configuration of the database apparatus 30. The database apparatus 30 has a processing device 32, a memory device 34, and a communication device 38. The respective elements of the database apparatus 30 are coupled to one another by a bus 39 for information communications.

The processing device 32 is a computer such as a CPU. Note that the processing device 32 may include one or more processors.

The memory device 34 is a magnetic memory device or a flash ROM. The memory device 34 is a recording medium readable by the processing device 32, and stores a plurality of programs including a control program executed by the processing device 32, relating information RI, log information LI, various kinds of information used by the processing device 32, etc.

FIG. 5 shows memory contents of the relating information RI. The relating information RI is information relating a user ID, identification information of the projector 10, and gained log information GLI. The relating information RI is present with respect to each projector 10.

The gained log information GLI represents an item of the log LG to be gained of the plurality of logs LG relevant to the projector 10. The gained log information GLI is changeable based on a change instruction input to the user terminal 40. The user terminal 40 is an example of “apparatus different from the electronic apparatus”.

The user ID is information for identification of the user U. ID is an abbreviation for Identifier. The user ID is e.g. a mail address of the user U or a GUID. GUID is an abbreviation for Globally Unique Identifier. The GUID is a 16-byte random numeric value. The identification information of the projector 10 is information for identification of the projector 10. The identification information of the projector 10 is e.g. a serial number of the projector 10 or a MAC address set for the communication device 18. MAC is an abbreviation for Media Access Control.

The plurality of logs LG relevant to the projector 10 in the embodiment are an error code, a number of rotations of the fan 17, and temperature information in the following explanation.

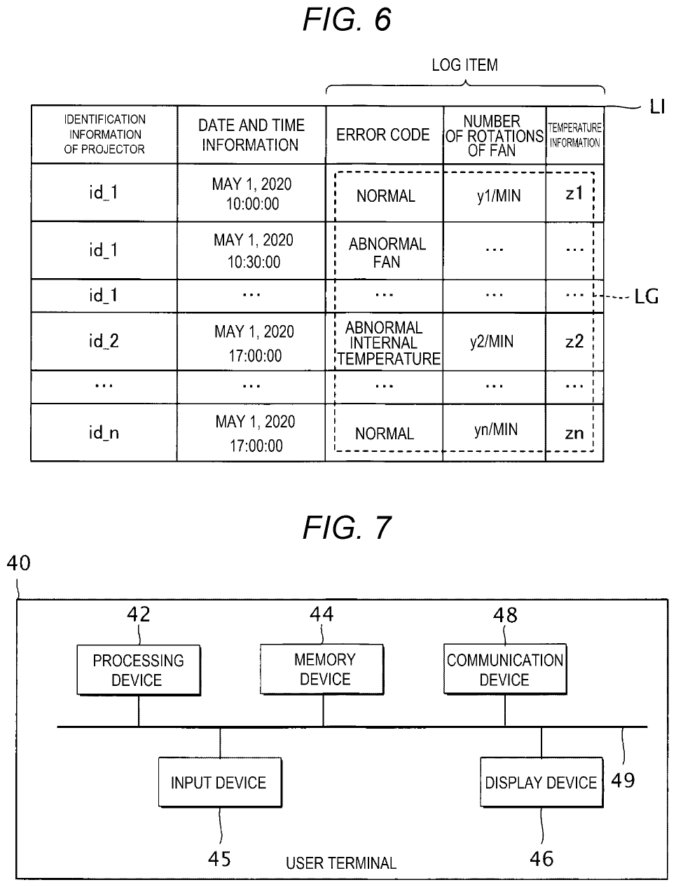

FIG. 6 shows memory contents of the log information LI. The log information LI includes logs LG relevant to the projector 10. The log information LI exemplified in FIG. 6 is information relating the identification information of the projector 10, date and time information, and the logs LG relevant to the projector 10 with respect to each projector 10. The log collection system 1 collects the logs LG relevant to the projector 10 with respect to each predetermined period. The predetermined period may be any period, e.g. ten minutes, thirty minutes, one hour, one day, or the like. The predetermined period is herein referred to as “log collection interval period”. In the exemplification of FIG. 6, the log collection interval period is thirty minutes.

The identification information of the projector 10 is information for identification of the projector 10. In the exemplification of FIG. 6, the identification information of the projector 10_1 is “id_1”, the identification information of the projector 10_2 is “id_2”, and the identification information of the projector 10_n is “id_n”. The date and time information is information representing the date and the time at which the plurality of logs LG relevant to the projector 10 are gained. The items of the logs LG as the error codes are e.g. “normal”, “abnormal fan”, and “abnormal internal temperature” in the exemplification of FIG. 6. The items of the logs LG as the numbers of rotations of the fan 17 are y1/min, y2/min, and yn/min as specific number of times. y1, y2, and yn are positive real numbers. The items of the logs LG as the temperature information are z1, z2, zn, etc. as values indicating specific temperatures. z1, z2, and zn are real numbers.

The explanation is returned to FIG. 4. The communication device 38 is hardware having a communication circuit for communication with another device via the communication network NW.

FIG. 7 shows a configuration of the user terminal 40. The user terminal 40 has a processing device 42, a memory device 44, an input device 45, a display device 46, and a communication device 48. The respective elements of the user terminal 40 are coupled to one another by a bus 49 for information communications.

The processing device 42 is a computer such as a CPU. Note that the processing device 42 may include one or more processors.

The memory device 44 is a magnetic memory device or a flash ROM. The memory device 44 is a recording medium readable by the processing device 42, and stores a plurality of programs including a control program executed by the processing device 42, various kinds of information used by the processing device 42, etc.

The input device 45 is a device by which the user U inputs information. The input device 45 includes one or more types of devices such as e.g. a pointing device, a keyboard, and a touch panel bonded to the surface of the display device 46.

The display device 46 displays various images under control by the processing device 42. For example, various display panels such as e.g. a liquid crystal display panel or an organic EL display panel are preferably used as the display device 46. EL is an abbreviation for Electro Luminescence.

The communication device 48 is hardware having a communication circuit for communication with another device via the communication network NW.

### 1.2. Functions of Log Collection System 1

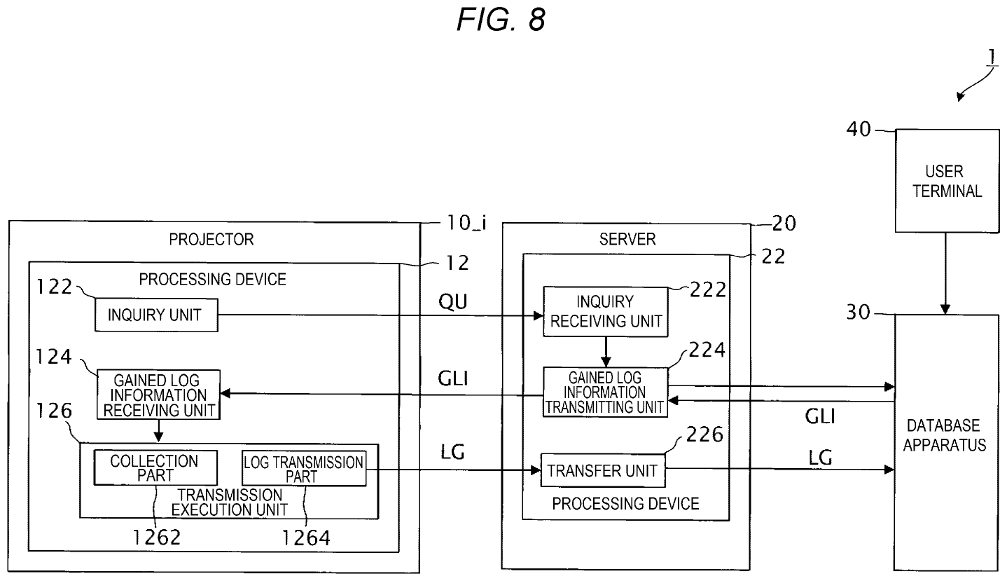

FIG. 8 shows functions of the log collection system 1. In the exemplification of FIG. 8, functions of the projector 10_i and the server 20 are shown. i is one of integers from 1 to n. The processing device 12 of the projector 10_i reads the control program from the memory device 14 and executes the read control program, and thereby, functions as an inquiry unit 122, a gained log information receiving unit 124, and a transmission execution unit 126. Further, the processing device 22 reads the control program from the memory device 24 and executes the read control program, and thereby, functions as an inquiry receiving unit 222, a gained log information transmitting unit 224, and a transfer unit 226.

The log collection system 1 has two operation stages of an advance preparation stage and a log collection stage. The advance preparation stage is a preparation stage for collecting the logs LG relevant to the projector 10. The log collection stage is a stage for collecting the logs LG relevant to the projector 10.

At the advance preparation stage, the user terminal 40 transmits the user ID, the identification information of the projector 10_i as an object of log collection, the gained log information GLI relevant to the projector 10_i to the database apparatus 30. The database apparatus 30 generates the relating information RI based on the received information and stores the information in the memory device 34.

At the log collection stage, the inquiry unit 122 transmits an inquiry QU regarding the gained log information GLI to the server 20 using the communication device 18. The inquiry QU contains an identifier indicating that an inquiry regarding the gained log information GLI is made and the identification information of the projector 10_i.

The inquiry receiving unit 222 receives the inquiry QU from the projector 10. When receiving the inquiry QU, the gained log information transmitting unit 224 transmits the identification information of the projector 10_i contained in the inquiry QU to the database apparatus 30. The database apparatus 30 transmits the gained log information GLI corresponding to the received identification information of the projector 10_i to the server 20. The server 20 stores the gained log information GLI. The gained log information transmitting unit 224 transmits the gained log information GLI to the projector 10_i.

The gained log information receiving unit 124 gains the gained log information GLI transmitted from the server 20 in response to the inquiry QU. The transmission execution unit 126 operates based on the received gained log information GLI. Specifically, when the gained log information GLI does not represent a first item, the transmission execution unit 126 does not transmit a first log LG relevant to the first item of the plurality of logs LG relevant to the projector 10_i to the server 20 and, when the gained log information GLI represents the first item, transmits the first log LG to the server 20. The first item is the error code, the number of rotations of the fan 17, or the temperature information in the first embodiment. When the first item is the error code, the first log LG is “normal”, “abnormal fan”, or “abnormal internal temperature”.

The more specific functions of the transmission execution unit 126 are explained. The transmission execution unit 126 has a collection part 1262 and a log transmission part 1264. When the gained log information GLI does not represent the first item, the collection part 1262 does not collect the first log LG and, when the gained log information GLI represents the first item, collects the first log LG. In other words, the collection part 1262 collects the log LG corresponding to the item represented by the gained log information GLI of the plurality of logs LG relevant to the projector 10_i, but does not collect the log LG corresponding to the item not represented by the gained log information GLI. The log transmission part 1264 transmits the first log LG collected by the collection part 1262 to the server 20.

The transfer unit 226 transfers the received first log LG to the database apparatus 30. When receiving the first log LG, the database apparatus 30 stores the received first log LG in the log information LI.

### 1.3. Operations of Log Collection System 1

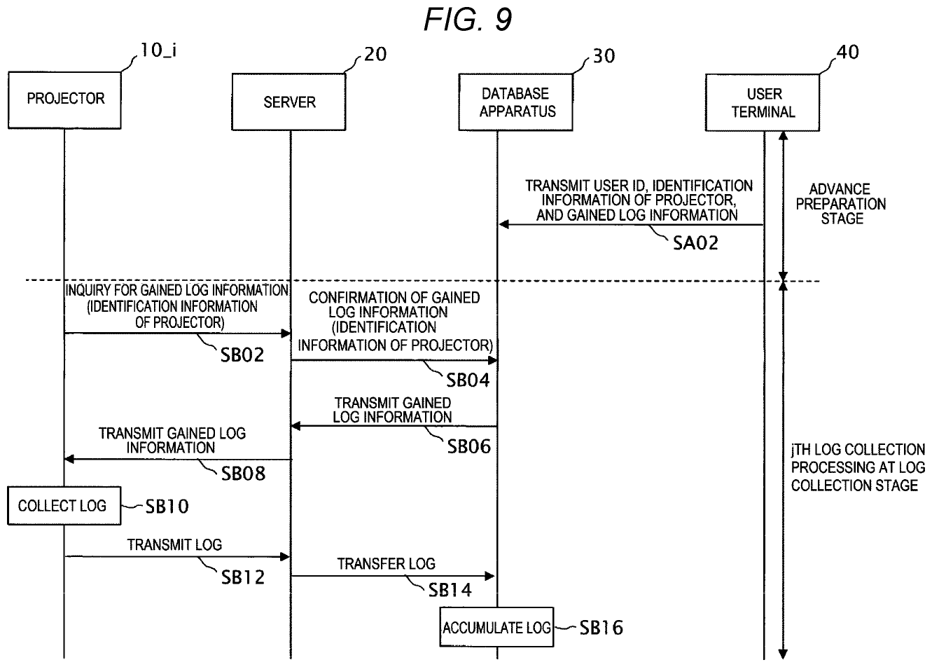

Operations of the log collection system 1 will be explained using FIG. 9.

FIG. 9 is a sequence diagram showing the operations of the log collection system 1. Processing at step SA02 shown in FIG. 9 is processing at the advance preparation stage. Processing at step SByy is processing at the log collection stage. yy is a positive integer. The log collection system executes log collection processing shown at the log collection stage in the respective log collection interval periods. The log collection processing is processing of collecting and accumulating the logs LG relevant to the projector 10_i in the log information LI. The log collection processing shown in FIG. 9 is jth log collection processing. j is an integer equal to or larger than 1. Parenthesized portions shown in FIG. 9 show information transmitted in communications.

At step SA02, the processing device 42 transmits the user ID, the identification information of the projector 10_i, and the gained log information GLI to the database apparatus 30 using the communication device 48. After the end of the processing at step SA02, the log collection system 1 ends the series of processing at the advance preparation stage shown in FIG. 9.

The jth log collection processing at the log collection stage is explained. At step SB02, the processing device 12 transmits the inquiry QU regarding the gained log information GLI to the server 20 using the communication device 18. The inquiry QU contains the identification information of the projector 10_i. The processing at step SB02 corresponds to the inquiry unit 122.

When receiving the inquiry QU, at step SB04, the processing device 22 transmits confirmation of the gained log information GLI to the database apparatus 30 using the communication device 28. The confirmation of the gained log information GLI includes the identification information of the projector 10_i contained in the inquiry QU.

At step SB06, the processing device 32 transmits the gained log information GLI corresponding to the identification information of the projector 10_i included in the confirmation of the received gained log information GLI to the server 20. When gaining the gained log information GLI, at step SB08, the processing device 22 transmits the gained log information GLI to the projector 10_i using the communication device 28. The processing at step SB08 corresponds to the gained log information transmitting unit 224.

When receiving the gained log information GLI, at step SB10, the processing device 12 of the projector 10_i collects the log LG corresponding to the item represented by the gained log information GLI. The processing at step SB10 corresponds to the collection part 1262. At step SB12, the processing device 12 of the projector 10_i transmits the collected log LG to the server 20 using the communication unit 18. The processing at step SB12 corresponds to the log transmission part 1264.

When receiving the log LG, at step SB14, the processing device 22 transfers the received log LG to the database apparatus 30 using the communication unit 28. When receiving the log LG, at step SB16, the processing device 32 accumulates the received log LG in the log information LI. After the end of the processing at step SB16, the log collection system 1 ends the series of processing at the log collection stage shown in FIG. 9.

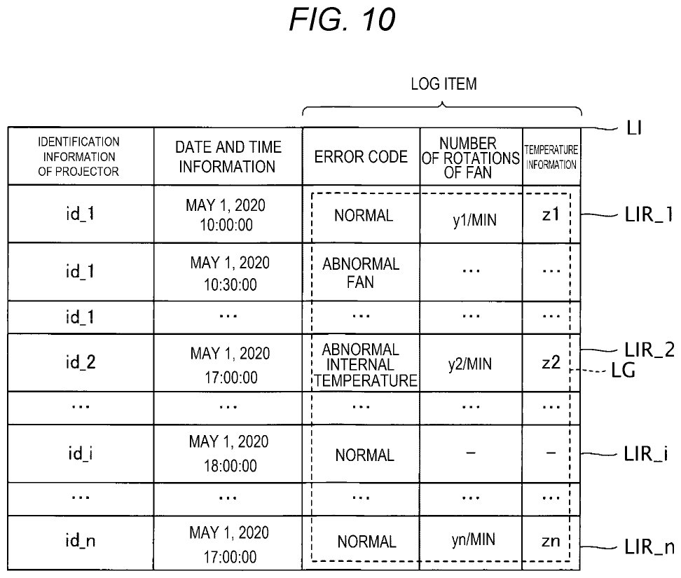

FIG. 10 shows memory contents of the log information LI after execution of the processing at step SB14. In the exemplification of FIG. 10, the item represented by the gained log information GLI is “error code” and the items not represented by the gained log information GLI are “number of rotations of fan” and “temperature information”. A record LIR_i contained in the log information LI exemplified in FIG. 10 is a record of collection of the log LG relevant to the projector 10_i. As exemplified by the record LIR_i, the log “normal” corresponding to the item “error code” is accumulated, but the logs LG corresponding to the item “number of rotations of fan” and the item “temperature information” are not accumulated. Further, the items represented the gained log information GLI of the relating information RI having the identification information of the projector 10_1, the relating information RI having the identification information of the projector 10_2, and the relating information RI having the identification information of the projector 10_n are “error code”, “number of rotations of fan”, and “temperature information”, and thus, in the records LIR_1, LIR_2, and LIR_n contained in the log information LI exemplified in FIG. 10, the logs LG corresponding to the item “error code”, the item “number of rotations of fan”, and the item “temperature information” are accumulated.

### 1.4. Effects of Log Collection System 1

As described above, the projector 10 is the electronic apparatus communicable with the server 20 that stores the gained log information GLI representing the item of the log LG to be gained, and the processing unit 12 of the projector 10 functions as the inquiry unit 122, the gained log information receiving unit 124, and the transmission execution unit 126. The inquiry unit 122 transmits the inquiry QU regarding the gained log information GLI to the server 20. The gained log information receiving unit 124 receives the gained log information GLI transmitted from the server 20 in response to the inquiry QU. The transmission execution unit 126 operates based on the gained log information GLI. More specifically, when the gained log information GLI does not represent the first item, the transmission execution unit 126 does not transmit the first log LG relevant to the first item of the plurality of logs LG relevant to the projector 10 to the server 20 and, when the gained log information GLI represents the first item, transmits the first log LG to the server 20.

According to the first embodiment, the user U may change the log LG transmitted to the server 20 of the plurality of logs LG relevant to the projector 10 only by changing the gained log information GLI, and thereby, the log collection system 1 may easily change the log LG transmitted to the server 20 of the plurality of logs LG relevant to the projector 10. The projector 10 transmits the inquiry QU regarding the gained log information GLI to the server 20, and thereby, when the gained log information GLI is changed, the projector 10 may collect the log LG corresponding to the item represented by the changed gained log information GLI. The log collection system 1 in the embodiment may promptly provide the log LG desired by the user U compared to a configuration of changing a program such as firmware or software installed in the projector 10.

Further, the projector 10 transmits only the log LG represented by the gained log information GLI to the server 20. Therefore, according to the first embodiment, the communication volume between the projector 10 and the server 20 may be reduced compared to a configuration of transmitting all of the plurality of logs LG relevant to the projector 10 to the server 20 and deleting the log LG not represented by the gained log information GLI.

The transmission execution unit 126 has the collection part 1262 and the log transmission part 1264. When the gained log information GLI does not represent the first item, the collection part 1262 does not collect the first log LG and, when the gained log information GLI represents the first item, collects the first log LG. The log transmission part 1264 transmits the first log LG collected by the collection part 1262 to the server 20.

According to the first embodiment, when the gained log information GLI does not represent the first item, the first log LG is not collected, and thus, the load on the projector 10 may be reduced compared to a configuration of collecting the first log LG, but not transmitting the first log LG when the gained log information GLI does not represent the first item.

The gained log information GLI stored in the server 20 is changeable based on a change instruction input to the user terminal 40.

According to the first embodiment, the log LG to be gained of the plurality of logs LG relevant to the projector 10 may be easily changed by the user U operating the user terminal 40.

Further, the server 20 has the gained log information transmitting unit 224 that transmits the gained log information GLI to the projector 10 when receiving the inquiry QU.

According to the first embodiment, the server 20 may transmit the gained log information GLI to the projector 10 when receiving the inquiry QU.

### 2. SECOND EMBODIMENT

A log collection system 1a in a second embodiment is different from the first embodiment in that the system has a PC in place of the server 20. PC is an abbreviation for Personal Computer. As below, the second embodiment will be explained. Note that the signs used in the first embodiment are also used for the elements having the same actions and functions as those of the first embodiment in the respective embodiments and the respective modified examples exemplified as below, and the detailed explanation of the respective elements will be appropriately omitted.

### 2.1. Outline of Log Collection System 1a

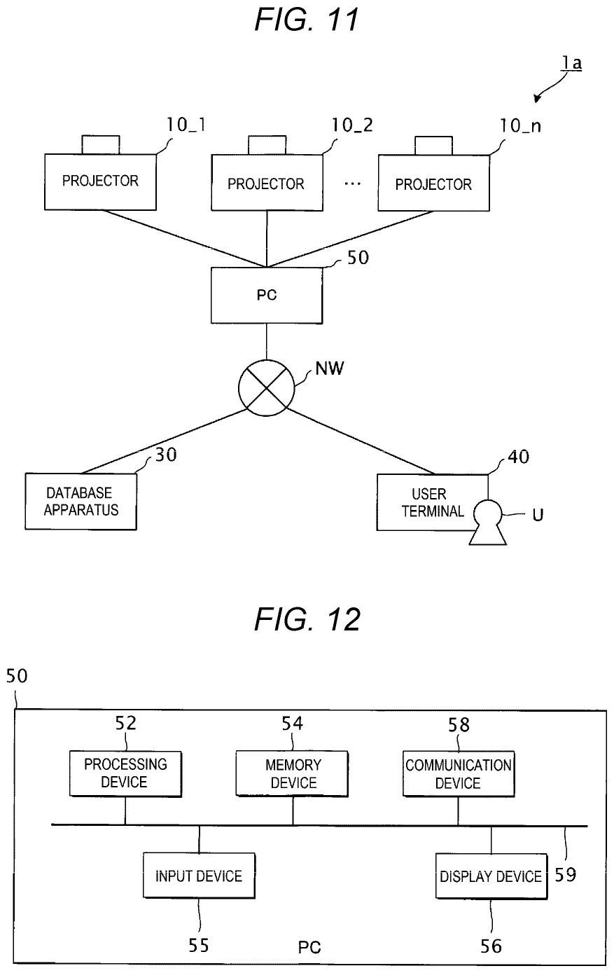

FIG. 11 is a block diagram showing a configuration of the log collection system 1a in the second embodiment. The log collection system 1a has the projector 10_1, the projector 10_2, . . . , the projector 10_n, a PC 50, the database apparatus 30, and the user terminal 40. The PC 50, the database apparatus 30, and the user terminal 40 are connected to the communication network NW. The projector 10_1, the projector 10_2, . . . , the projector 10_n, and the PC 50 are coupled to one another.

FIG. 12 shows a configuration of the PC 50. The PC 50 has a processing device 52, a memory device 54, an input device 55, a display device 56, and a communication device 58. The respective elements of the PC 50 are coupled to one another by a bus 59 for information communications.

The processing device 52 is a computer such as a CPU. Note that the processing device 52 may include one or more processors.

The memory device 54 is a magnetic memory device or a flash ROM. The memory device 54 is a recording medium readable by the processing device 52, and stores a plurality of programs including an application program executed by the processing device 52 and a control program executed by the processing device 52, various kinds of information used by the processing device 52, etc.

The input device 55 is a device by which the user using the PC 50 inputs information. The input device 55 includes one or more types of devices such as e.g. a pointing device, a keyboard, and a touch panel bonded to the surface of the display device 56.

The display device 56 displays various images under control by the processing device 52. For example, various display panels such as e.g. a liquid crystal display panel or an organic EL display panel are preferably used as the display device 56.

The communication device 58 is hardware for communication with another device via the communication network NW.

### 2.2. Functions of Log Collection System 1a

The functions of the log collection system 1a are the same as the functions of the server 20 by reading an application program and executing the application program using the processing device 52. Therefore, the explanation of the functions of the log collection system 1a is omitted.

### 2.3. Effects of Log Collection System 1a

According to the second embodiment, the projector 10_1 to projector 10_n are coupled to the PC 50, and thereby, the load on the communication network NW may be reduced.

### 3. THIRD EMBODIMENT

The log collection system 1 in the first embodiment transmits the inquiry QU for the gained log information GLI to the server 20 when gaining the log LG. On the other hand, in a log collection system 1b in a third embodiment, a server 20b transmits a change of the item of the log LG to the projector 10 when the item of the log LG is changed.

### 3.1. Outline of Log Collection System 1b

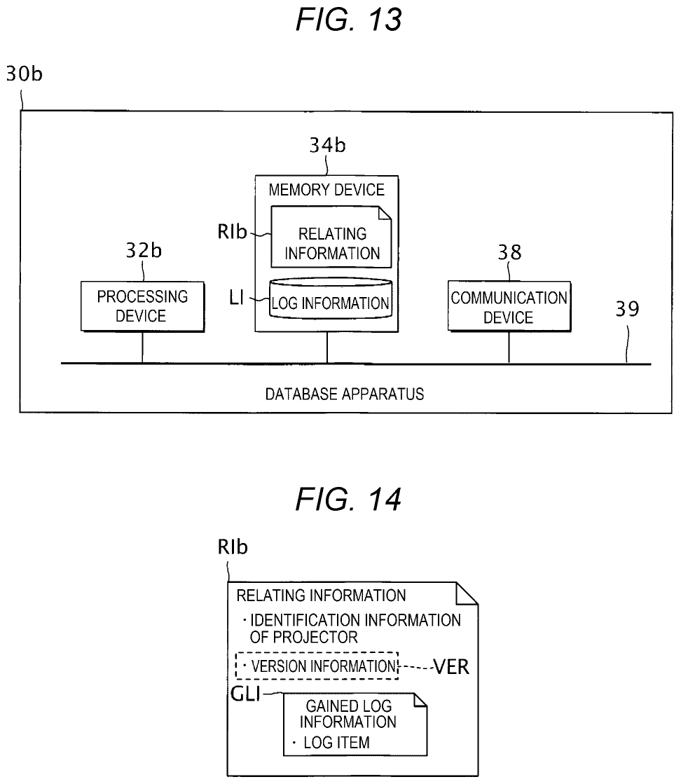

FIG. 13 shows a configuration of a database apparatus 30b in the third embodiment. The database apparatus 30b has a processing device 32b, a memory device 34b, and the communication device 38.

The processing device 32b is a computer such as a CPU. Note that the processing device 32b may include one or more processors.

The memory device 34b is a magnetic memory device or a flash ROM. The memory device 34b is a recording medium readable by the processing device 32b, and stores a plurality of programs including a control program executed by the processing device 32b, relating information RIb, log information LI, various kinds of information used by the processing device 32b, etc.

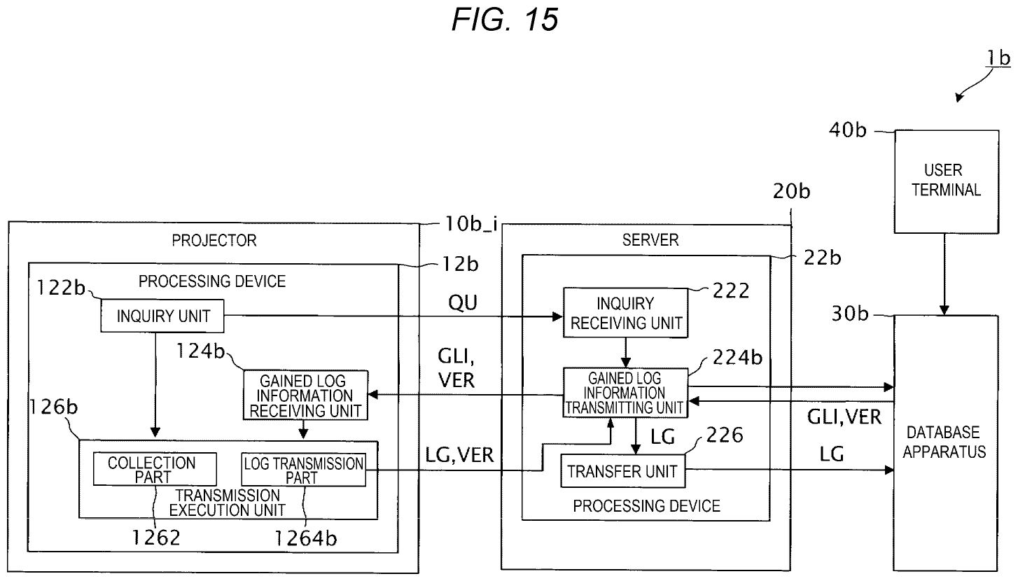

FIG. 14 shows memory contents of the relating information RIb. The relating information RIb has version information VER, but does not have the user ID compared to the relating information RI. The version information VER represents a value indicating the version of the gained log information GLI. For example, the version information VER is a numerical value e.g. “1”, “2”, or the like. The gained log information GLI having different versions from each other usually represents the items of the different logs LG from each other, but may represent the items of the same log LG as each other.

### 3.2. Functions of Log Collection System 1b

FIG. 15 shows a configuration of the log collection system 1b in the third embodiment. A processing device 22b included in the server 20b in the third embodiment reads the control program from the memory device 24 included in the server 20b and executes the read control program, and thereby, functions as the inquiry receiving unit 222, a gained log information transmitting unit 224b, and the transfer unit 226. Further, a processing device 12b included in a projector 10b_i in the third embodiment reads the control program from the memory device 14 included in the projector 10b_i in the third embodiment and executes the read control program, and thereby, functions as an inquiry unit 122b, a gained log information receiving unit 124b, and a transmission execution unit 126b.

At the advance preparation stage, a user terminal 40b in the third embodiment transmits the gained log information GLI of the projector 10 and the version information VER corresponding to the gained log information GLI. The version information VER may be set by the user U or a value numbered by the user terminal 40b. The database apparatus 30b generates the relating information RIb based on the received information and stores the generated relating information RIb in the memory device 34b.

At the log collection stage, the inquiry unit 122b executes in the respective log collection interval periods. The inquiry unit 122b transmits the inquiry QU regarding the gained log information GLI to the server 20b using the communication device 18 if the gained log information GLI has not gained. The inquiry QU contains the identification information of the projector 10b_i. When the gained log information GLI is gained once, the inquiry unit 122b does not transmit the inquiry QU to the server 20b and the transmission execution unit 126b is executed.

The gained log information transmitting unit 224b transmits confirmation of the gained log information GLI to the database apparatus 30b when the inquiry receiving unit 222 receives the inquiry QU. The database apparatus 30b transmits the gained log information GLI and the version information VER of the gained log information GLI to the server 20b. The server 20b stores the gained log information GLI and the version information VER in the memory device 24. Further, when new gained log information GLI and version information VER of the new gained log information GLI are received from the user terminal 40b, the gained log information GLI and the version information VER stored by the memory device 24 are updated by the received gained log information GLI and version information VER. The version information VER stored by the memory device 24 is an example of “first version information”.

The gained log information transmitting unit 224b transmits the gained log information GLI and the version information VER to the projector 10b_i.

The gained log information receiving unit 124b receives the gained log information GLI and the version information VER transmitted from the server 20b in response to the inquiry QU. The gained log information receiving unit 124b stores the gained gained log information GLI and version information VER in the memory device 14.

When the gained log information receiving unit 124b receives the gained log information GLI or receives an execution instruction from the inquiry unit 122b, the transmission execution unit 126b collects the first log LG and transmits the first log LG and the version information VER representing the version of the gained log information GLI to the server 20b. The transmitted version information VER is an example of “second version information”.

The gained log information transmitting unit 224b compares the version information VER stored in the memory device 24 and the version information VER received from the projector 10b_i. Note that the gained log information transmitting unit 224b determines whether or not updating of the version information VER stored in the memory device 24 is necessary before the comparison. Specifically, the gained log information transmitting unit 224b determines that updating of the version information VER stored in the memory device 24 is necessary when the date and time at which the version information VER stored in the memory device 24 is stored is before the current date and time by the log collection interval period or more.

When updating of the version information VER stored in the memory device 24 is necessary, the gained log information transmitting unit 224b transmits confirmation of the version information VER to the database apparatus 30b. When receiving the confirmation of the version information VER, the database apparatus 30b transmits the version information VER to the server 20b. When receiving the version information VER, if the version information VER has been updated, the gained log information transmitting unit 224b updates the version information VER stored in the memory device 24 using the received version information VER. When the version information VER is updated, the gained log information transmitting unit 224b transmits the confirmation of the gained log information GLI to the database apparatus 30b and updates the gained log information GLI stored in the memory device 24.

As a result of the comparison between the version information VER, when the version information VER stored in the memory device 24 and the version information VER received from the projector 10b_i are different, the gained log information transmitting unit 224b transmits the gained log information GLI stored in the server 20b and the version information VER stored in the memory device 24 to the projector 10b_i. On the other hand, when the version information VER stored in the memory device 24 and the version information VER received from the projector 10b-i are the same, the gained log information transmitting unit 224b controls the transfer unit 226 to transfer the log LG received from the projector 10b_i to the database apparatus 30b.

### 3.3. Operations of Log Collection System 1b

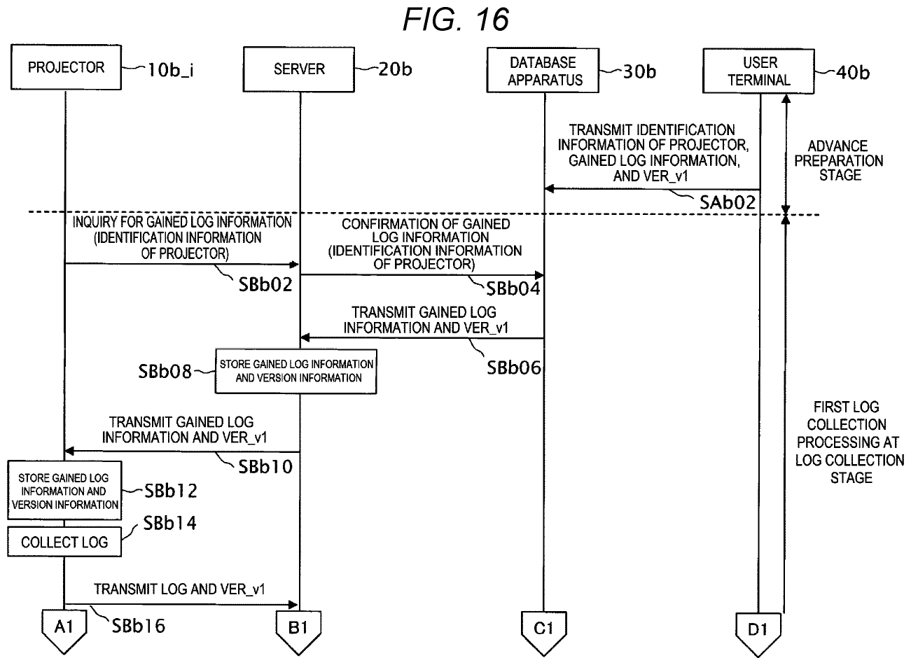

Operations of the log collection system 1b will be explained using FIGS. 16, 17, 18, and 19.

FIGS. 16, 17, 18, and 19 are sequence diagrams showing the operations of the log collection system 1b. Processing at step SAb02 shown in FIG. 16 is processing at the advance preparation stage. Processing at step SBbyy shown in FIGS. 16, 17, 18, and 19 is processing at the log collection stage. yy is a positive integer. Parenthesized portions shown in FIG. 16 show information transmitted in communications. Further, regarding the information transmitted in communications in FIGS. 16, 17, 18, and 19, version information VER representing that the version of the gained log information GLI is “1” is shown by “VER_v1” and referred to as “version information VER_v1” in the following description. Similarly, version information VER representing that the version of the gained log information GLI is “2” is shown by “VER_v2” and referred to as “version information VER_v2” in the following description.

The processing at the advance preparation stage is explained. At step SAb02, the processing device 42 in the third embodiment transmits the identification information of the projector 10b_i, the version information VER_v1, and the gained log information GLI to the database apparatus 30b using the communication device 48. After the end of the processing at step SAb02, the log collection system 1b ends the series of processing at the advance preparation stage shown in FIG. 16.

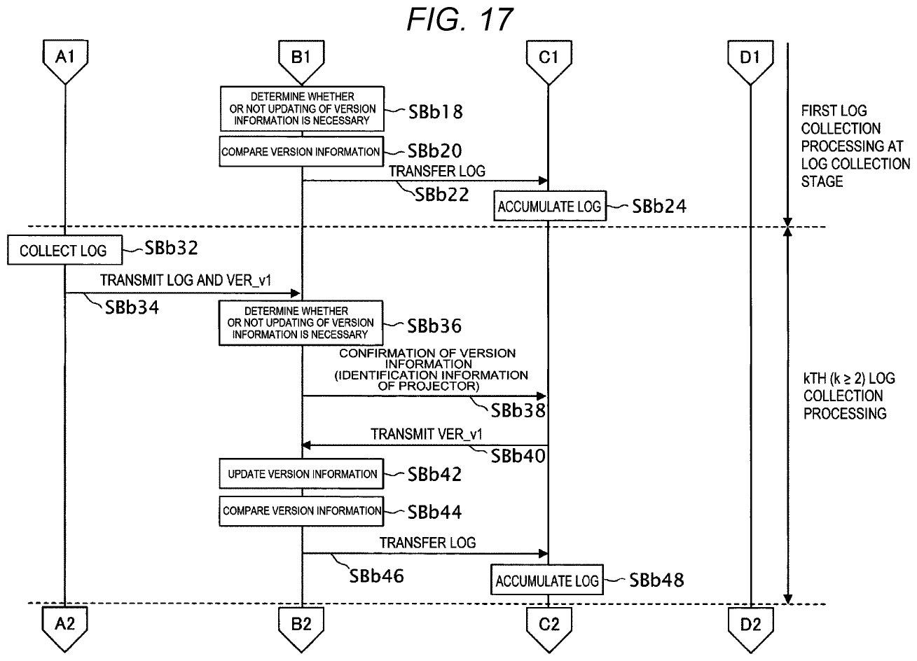

First log collection processing at the log collection stage will be explained using FIGS. 16 and 17. At step SBb02, the processing device 12b has not gained the gained log information GLI, and transmits the inquiry QU regarding the gained log information GLI to the server 20b using the communication device 18. The inquiry QU contains the identification information of the projector 10b_i. The processing at step SBb02 corresponds to the inquiry unit 122b.

When receiving the inquiry QU, at step SBb04, the processing device 22b transmits confirmation of the gained log information GLI to the database apparatus 30b using the communication device 28. The confirmation of the gained log information GLI includes the identification information of the projector 10b_i contained in the inquiry QU.

At step SBb06, the processing device 32b transmits the gained log information GLI and the version information VER_v1 corresponding to the received identification information of the projector 10b_i to the server 20b. When receiving the gained log information GLI and the version information VER_v1, at step SBb08, the processing device 22b stores the gained log information GLI and the version information VER_v1 in the memory device 24. Then, at step SBb10, the processing device 22b transmits the gained log information GLI and the version information VER_v1 to the projector 10b_i using the communication device 28. The processing at step SBb10 corresponds to the gained log information transmitting unit 224b.

When receiving the gained log information GLI and the version information VER_v1, at step SBb12, the processing device 12b of the projector 10b_i stores the gained log information GLI and the version information VER_v1 in the memory device 14 of the projector 10b_i. Then, at step SBb14, the processing device 12b of the projector 10b_i collects the log LG corresponding to the item represented by the gained log information GLI. The processing at step SBb14 corresponds to the collection part 1262. At step SBb16, the processing device 12b of the projector 10b_i transmits the log LG collected by the collection part 1262 and the version information VER_v1 stored in the memory device 14 to the server 20b using the communication unit 18. The processing at step SBb16 corresponds to a log transmission part 1264b.

When receiving the log LG and the version information VER_v1, at step SBb18, the processing device 22b determines whether or not updating of the version information VER stored in the memory device 24 is necessary. The date and time of the processing at step SBb08 at which the version information VER stored in the memory device 24 is stored is not before by the log collection interval period or more compared to the date and time of the processing at step SBb18. Therefore, at step SBb20, the processing device 22b compares the version information VER stored in the memory device 24 and the version information VER received from the projector 10b_i without updating of the version information VER stored in the memory device 24. The version information VER stored in the memory device 24 and the version information VER received from the projector 10b_i are the same version information VER_v1 as each other. Therefore, at step SBb22, the processing device 22b transfers the log LG received from the projector 10b_i to the database apparatus 30b.

When receiving the log LG, at step SBb24, the processing device 32b of the database apparatus 30b accumulates the received log LG in the log information LI. After the end of the processing at step SBb24, the log collection system 1b ends the first log collection processing at the log collection stage shown in FIGS. 16 and 17.

kth log collection processing after the execution of the first log collection processing and until updating of the version information VER at the log collection stage will be explained using FIG. 17. k is an integer equal to or larger than 2. When the log collection interval period elapses after the execution of the (k−1)th log collection processing, at step SBb32, the processing device 12b of the projector 10b_i collects the log LG corresponding to the item represented by the gained log information GLI stored in the memory device 14. At step SBb34, the processing device 12b of the projector 10b_i transmits the log LG collected by the collection part 1262 and the version information VER_v1 stored in the memory device 14 to the server 20b using the communication unit 28.

When receiving the log LG and the version information VER, at step SBb36, the processing device 22b determines whether or not updating of the version information VER_v1 stored in the memory device 24 is necessary. The date and time of the processing at step SBb08 at which the version information VER_v1 stored in the memory device 24 is stored is before by the log collection interval period or more compared to the date and time of the processing at step SBb36. Therefore, to update the version information VER_v1 stored in the memory device 24, at step SBb38, the processing device 22b transmits confirmation of the version information VER to the database apparatus 30b using the communication device 28. The confirmation of the version information VER includes the identification information of the projector 10b_i.

When receiving the confirmation of the version information VER, at step SBb40, the processing device 32b of the database apparatus 30b transmits the version information VER_v1 corresponding to the identification information of the projector 10b_i included in the confirmation of the version information VER to the server 20b using the communication device 38.

When receiving the version information VER_v1, at step SBb42, the processing device 22b updates the version information VER_v1 stored in the memory device 24 using the received version information VER_v1. Note that, in the processing at step SBb42, the received version information VER and the version information VER stored in the memory device 24 are the same version information VER_v1 as each other, and therefore, the processing device 22b does not necessarily execute the processing at step SBb42.

After the end of the processing at step SBb42, at step SBb44, the processing device 22b compares the version information VER stored in the memory device 24 and the version information VER received from the projector 10b_i. The version information VER stored in the memory device 24 and the version information VER received from the projector 10b_i are the same version information VER_v1 as each other. Therefore, at step SBb46, the processing device 22b transfers the log LG received from the projector 10b_i to the database apparatus 30b.

When receiving the log LG, at step SBb48, the processing device 32b of the database apparatus 30b accumulates the received log LG in the log information LI. After the end of the processing at step SBb48, the log collection system 1b ends the kth log collection processing at the log collection stage shown in FIG. 17.

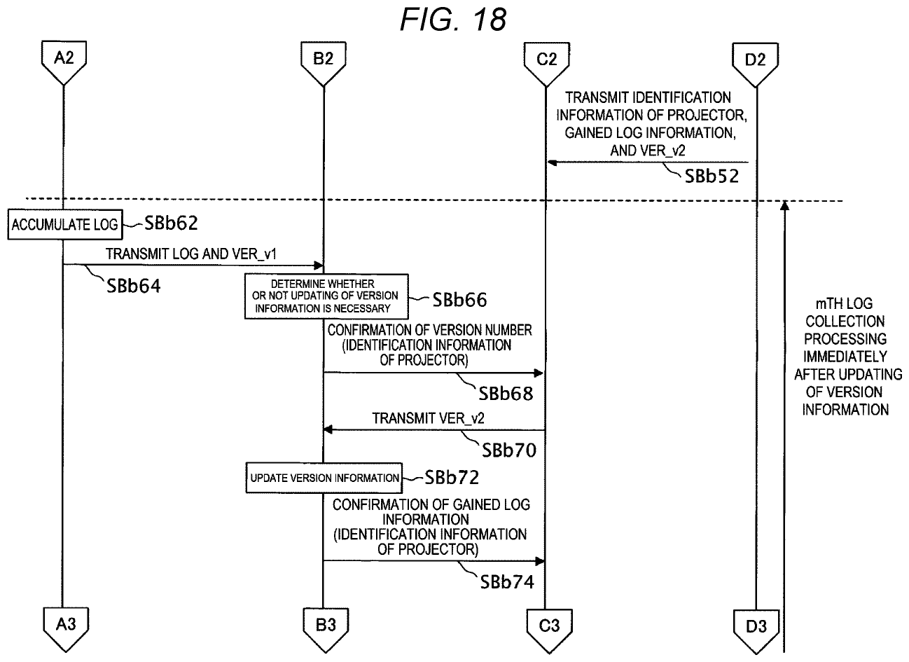

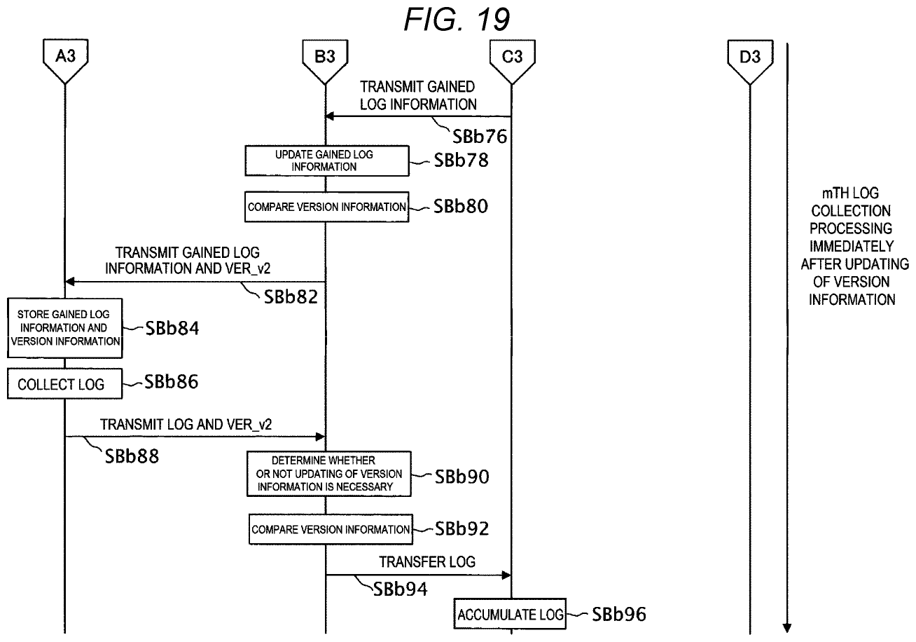

mth log collection processing at the log collection stage immediately after the version information VER is updated by the user terminal 40b will be explained using FIGS. 18 and 19. m is an integer larger than k.

After execution of the (m−1)th log collection processing and before execution of the mth log collection processing, at step SBb52, the processing device 42 in the third embodiment transmits the identification information of the projector 10b_i, the updated gained log information GLI, and the version information VER_v2 to the database apparatus 30b using the communication device 48.

The mth log collection processing is explained. At step SBb62, the processing device 12b of the projector 10b_i collects the log LG corresponding to the item represented by the gained log information GLI stored in the memory device 14. At step SBb64, the processing device 12b of the projector 10b_i transmits the log LG collected by the collection part 1262 and the version information VER_v1 stored in the memory device 14 to the server 20b using the communication unit 28.

When receiving the log LG and the version information VER_v1, at step SBb66, the processing device 22b determines whether or not updating of the version information VER stored in the memory device 24 is necessary. The date and time of the processing at step SBb42 at which the version information VER_v1 stored in the memory device 24 is stored is before by the log collection interval period or more compared to the date and time of the processing at step SBb66. Therefore, to update the version information VER stored in the memory device 24, at step SBb68, the processing device 22b transmits confirmation of the version information VER to the database apparatus 30b using the communication device 28. The confirmation of the version information VER includes the identification information of the projector 10b_i.

When receiving the confirmation of the version information VER, at step SBb70, the processing device 32b of the database apparatus 30b transmits the version information VER_v2 corresponding to the identification information of the projector 10b_i included in the confirmation of the version information VER to the server 20b using the communication device 38.

When receiving the version information VER_v2, at step SBb72, the processing device 22b updates the version information VER stored in the memory device 24 using the received version information VER_v2. In the processing at step SBb72, the received version information VER and the version information VER stored in the memory device 24 are different. Specifically, the received version information VER is the version information VER_v2, and the version information VER stored in the memory device 24 is the version information VER_v1. Therefore, at step SBb74, the processing device 22b transmits the confirmation of the gained log information GLI to the database apparatus 30b using the communication device 28. The confirmation of the gained log information GLI includes the identification information of the projector 10b_i.

When receiving the confirmation of the gained log information GLI, at step SBb76, the processing device 32b of the database apparatus 30b transmits the gained log information GLI corresponding to the identification information of the projector 10b_i included in the confirmation of the gained log information GLI to the server 20b using the communication device 38.

When receiving the gained log information GLI, at step SBb78, the processing device 22b updates the gained log information GLI stored in the memory device 24 using the received gained log information GLI.

After the end of the processing at step SBb78, at step SBb80, the processing device 22b compares the version information VER stored in the memory device 24 and the version information VER received from the projector 10b_i. The version information VER stored in the memory device 24 and the version information VER received from the projector 10b_i are different from each other. Specifically, the version information VER stored in the memory device 24 is the version information VER_v2 and the version information VER received from the projector 10b_i is the version information VER_v1. Therefore, at step SBb82, the processing device 22b transmits the gained log information GLI stored in the memory device 24 and the version information VER_v2 using the communication device 28.

When receiving the gained log information GLI and the version information VER_v2, at step SBb84, the processing device 12b of the projector 10b_i stores the gained log information GLI and the version information VER_v2 in the memory device 14. Then, at step SBb86, the processing device 12b of the projector 10b_i collects the log LG corresponding to the item represented by the gained log information GLI stored in the memory device 14. After collecting the log LG, at step SBb88, the processing device 12b transmits the log G and the version information VER_v2 to the server 20b using the communication unit 18.

When receiving the log LG and the version information VER_v2, at step SBb90, the processing device 22b determines whether or not updating of the version information VER stored in the memory device 24 is necessary. Here, it is clear that the updating of the version information VER is not necessary, and the processing device 22b does not necessarily execute the processing at step SBb90.

After the end of the processing at step SBb90, at step SBb92, the processing device 22b compares the version information VER stored in the memory device 24 and the version information VER received from the projector 10b_i. The version information VER stored in the memory device 24 and the version information VER received from the projector 10b_i are the same version information VER_v2 as each other. Therefore, at step SBb94, the processing device 22b transfers the log LG received from the projector 10b_i to the database apparatus 30b.

When receiving the log LG, at step SBb96, the processing device 32b of the database apparatus 30b accumulates the received log LG in the log information LI. After the end of the processing at step SBb96, the log collection system 1b ends the mth log collection processing at the log collection stage shown in FIGS. 18 and 19.

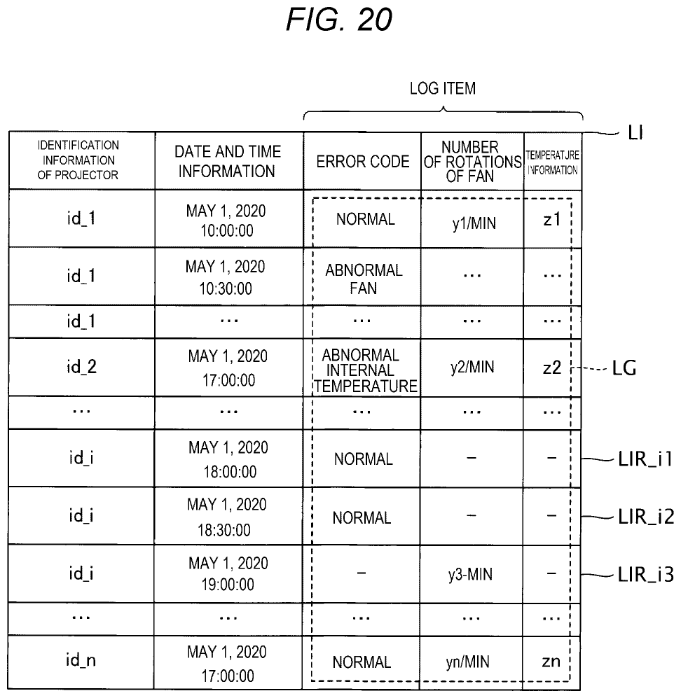

FIG. 20 shows memory contents of the log information LI after execution of the processing at step SBb96. In the exemplification of FIG. 20, the gained log information GLI corresponding to the version information VER_v1 representing that the version of the gained log information GLI is “1” represents the item “error code”. The gained log information GLI corresponding to the version information VER_v2 representing that the version of the gained log information GLI is “2” represents the item “number of rotations of fan”. Further, in the exemplification of FIG. 20, the version of the gained log information GLI is updated from “1” to “2” before the third log collection processing.

A record LIR_i1, a record LIR_i2, and a record LIR_i3 contained in the log information LI exemplified in FIG. 20 are records of accumulation of the logs LG relevant to the projector 10b_i. A record LIR_ix indicates a log LG accumulated by the xth log collection processing. x is an integer from 1 to 3. As exemplified by the record LIR_i1 and the record LIR_i2, the log “normal” corresponding to the item “error code” is accumulated, but the logs corresponding to the item “number of rotations of fan” and the item “temperature information” are not accumulated. Further, as exemplified by the record LIR_i3, the log “y3/min” corresponding to the item “number of rotations of fan” is accumulated, but the logs corresponding to the item “error code” and the item “temperature information” are not accumulated.

### 3.4. Effects of Log Collection System 1b

As described above, in the third embodiment, the gained log information GLI stored in the server 20b can be version-upgraded. The server 20b stores the first version information VER representing the version of the gained log information GLI. The transmission execution unit 126 transmits the first log LG and the second version information VER representing the version of the gained log information GLI to the server 20b. When the first version information VER and the second version information VER are different, the gained log information transmitting unit 224b transmits the gained log information GLI stored in the server 20b and the first version information VER to the projector 10b_i.

According to the third embodiment, the projector 10b_i transmits the inquiry QU to the server 20b only when the gained log information GLI is not stored, but does not transmit the inquiry QU to the server 20b when the gained log information GLI is stored. Therefore, the log collection system 1b in the third embodiment may suppress the volume of communication between the projector 10b_i and the server 20b compared to the log collection system 1. Further, the version information VER received from the projector 10b_i and the version information VER stored by the server 20b are compared, and thereby, updating of the gained log information GLI by the user U may be detected.

### 4. FOURTH EMBODIMENT

A log collection system 1d in a fourth embodiment is different from the second embodiment in that the system has the server 20.

### 4.1. Outline of Log Collection System 1d

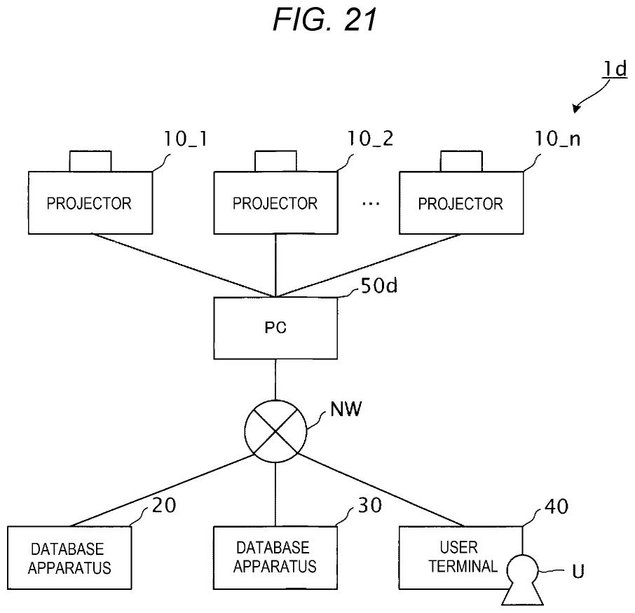

FIG. 21 is a block diagram showing a configuration of the log collection system 1d. The log collection system 1d has the projector 10_1, the projector 10_2, . . . , the projector 10_n, a PC 50d, the server 20, the database apparatus 30, and the user terminal 40. The PC 50d, the server 20, the database apparatus 30, and the user terminal 40 are coupled to the communication network NW. The projector 10_1, the projector 10_2, . . . , the projector 10_n, and the PC 50d are coupled to one another.

### 4.2. Operations of Log Collection System 1d

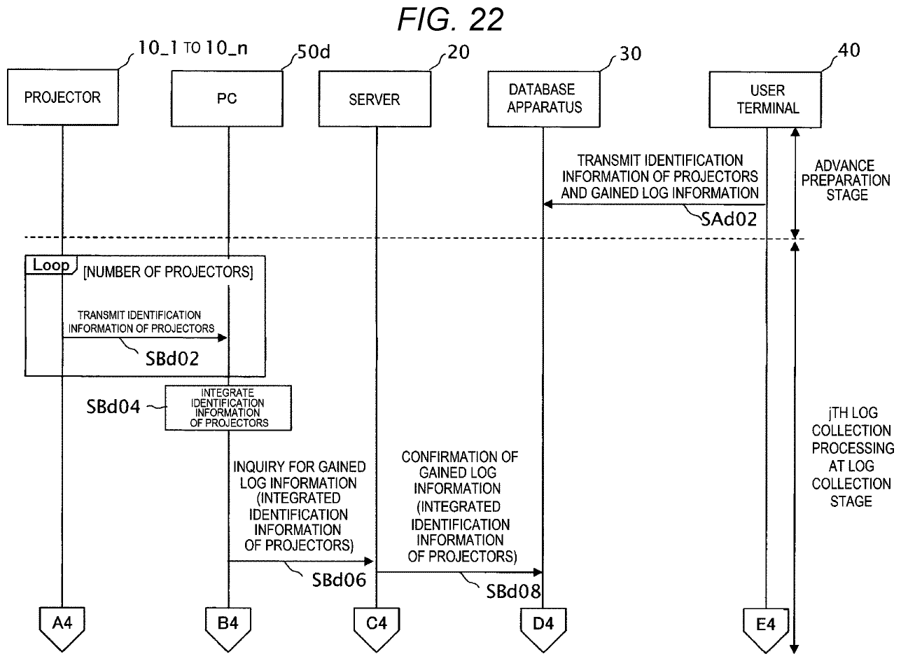

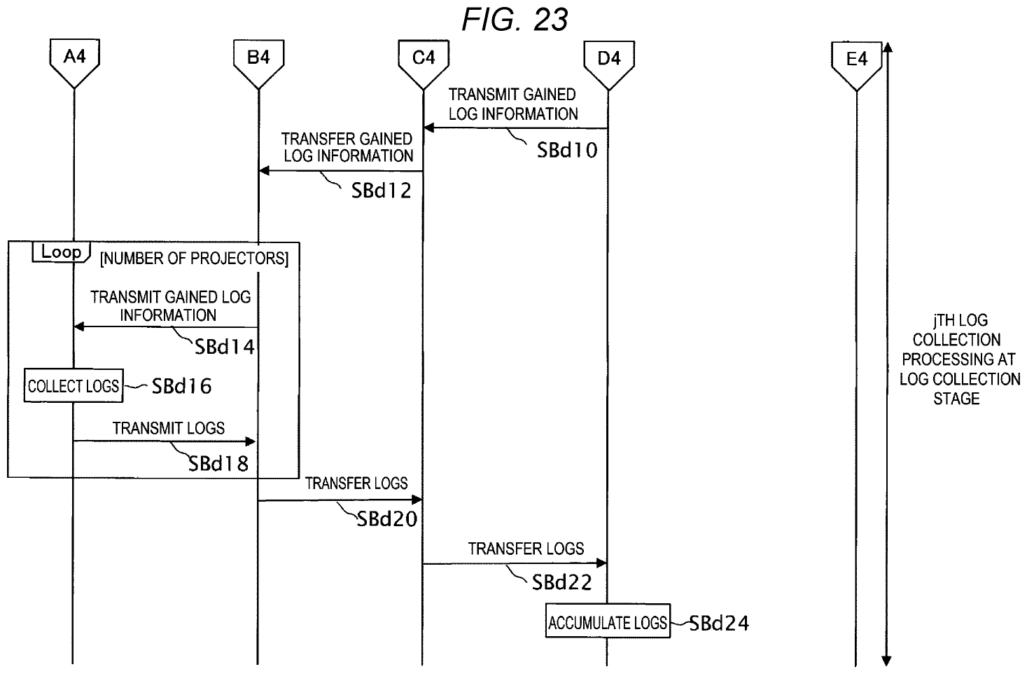

Operations of the log collection system 1d will be explained using FIGS. 22 and 23.

FIGS. 22 and 23 are sequence diagrams showing the operations of the log collection system 1d. Processing at step SAd02 shown in FIG. 22 is processing at the advance preparation stage. Processing at step SBdyy shown in FIGS. 22 and 23 is processing at the log collection stage. yy is a positive integer. The log collection system 1d executes the processing at the log collection stage in each log collection interval period. Parenthesized portions shown in FIG. 22 show information transmitted in communications.

The processing at the advance preparation stage is explained. At step SAd02, the processing device 42 in the fourth embodiment transmits the identification information of the projector 10_i and the gained log information GLI to the database apparatus 30 using the communication device 48. After the end of the processing at step SAd02, the log collection system 1d ends the series of processing at the advance preparation stage shown in FIG. 22.

jth log collection processing at the log collection stage is explained. The log collection system 1d executes processing at step SBd02 for each projector 10. At step SBd02, the processing device 12 of the projector 10_i transmits the identification information of the projector 10_i to the PC 50d using the communication device 18.

After the projector 10_1 to projector 10_n execute the processing at step SBd02, at step SBd04, the processing device 52 of the PC 50d integrates the received identification information of the projectors 10. For example, when the identification information of the projector 10_1 is “id_1”, the identification information of the projector 10_2 is “id_2”, and the identification information of the projector 10_n is “id_n”, the processing device 52 of the PC 50d generates an integration result as “id_1, id_2, . . . , id_n”.

After the identification information of the projectors 10 is integrated, at step SBd06, the processing device 52 of the PC 50d transmits the inquiry QU for the gained log information GLI to the server 20 using the communication device 58. The inquiry contains the integrated identification information of the projectors 10.

When receiving the inquiry QU, at step SBd08, the processing device 22 transmits confirmation of the gained log information GLI to the database apparatus 30. The confirmation of the gained log information GLI includes the integrated identification information of the projectors 10.

When receiving the confirmation of the gained log information GLI, at step SBd10, the processing device 32 transmits the gained log information GLI corresponding to the respective projector 10_1 to projector 10_n for which the identification information is integrated to the server 20 using the communication device 38. When receiving the gained log information GLI corresponding to the respective projector 10_1 to projector 10_n, at step SBd12, the processing device 22 transfers the gained log information GLI corresponding to the respective projector 10_1 to projector 10_n to the PC 50d.

When receiving the gained log information GLI corresponding to the respective projector 10_1 to projector 10_n, at step SBd14, the processing device 52 transmits the gained log information GLI of the projector 10_i to the projector 10_i for each i from 1 to n. When receiving the gained log information GLI, at step SBd16, the processing device 12 of the projector 10_i collects the log LG corresponding to the received gained log information GLI for each i from 1 to n. After collecting the log LG, at step SBd18, the processing device 12 of the projector 10_i transmits the log LG to the PC 50d using the communication device 18 for each i from 1 to n.

When receiving the logs LG from the respective projectors 10_i (i from 1 to n), at step SBd20, the processing device 52 transfers the received logs LG to the server 20 using the communication device 58. When receiving the logs LG, at step SBd22, the processing device 22 transfers the logs LG to the database apparatus 30 using the communication device 28. At step SBd24, the processing device 32 accumulates the received logs LG in the log information LI. After the end of the processing at step SB24, the log collection system 1d ends the series of processing at the log collection stage shown in FIGS. 22 and 23.

### 4.3. Effects of Log Collection System 1d

As described above, according to the fourth embodiment, the PC 50d integrates the identification information of the projector 10_1 to projector 10_n, and thereby, the load on the server 20 may be reduced compared to a case where the respective projector 10_1 to projector 10_n transmit inquiries QU to the server 20.

### 5. MODIFIED EXAMPLES

The above described embodiments may be deformed in various configurations. Specific deformed configurations will be exemplified as below. Two or more configurations arbitrarily selected from the following exemplifications may be appropriately combined to be mutually consistent with one another. Note that, in the modified examples exemplified as below, regarding the elements having actions and functions equal to those of the embodiments, the signs referred to in the above description will also be used and the detailed description of the respective elements will be appropriately omitted.

### 5.1. First Modified Example

In the above described respective embodiments, the servers 20 and the database apparatuses 30 may be the same apparatuses.

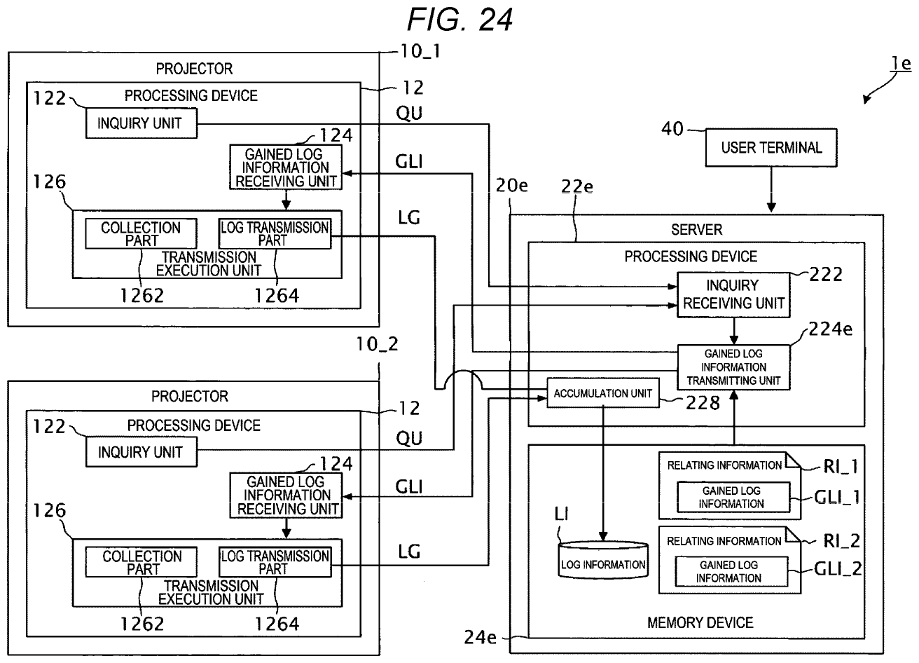

FIG. 24 shows functions of a log collection system 1e in a first modified example. The log collection system 1e has the projector 10_1, the projector 10_2, a server 20e, and the user terminal 40.

The server 20e has a processing device 22e, a memory device 24e, and a communication device 28e. The processing device 22e is a computer such as a CPU. Note that the processing device 22e may include one or more processors. The memory device 24e is a magnetic memory device or a flash ROM. The memory device 24e is a recording medium readable by the processing device 22e, and stores a plurality of programs including a control program executed by the processing device 22e, relating information RI_1, relating information RI 2, log information LI, various kinds of information used by the processing device 22e, etc.

The relating information RI_1 is information relating identification information of the projector 10_1 and gained log information GLI_1. The identification information of the projector 10_1 contained in the relating information RI_1 is an example of “second identification information”. The gained log information GLI_1 is an example of “first gained log information”.

The relating information RI 2 is information relating identification information of the projector 10_2 and gained log information GLI_2. The identification information of the projector 10_2 contained in the relating information RI 2 is an example of “third identification information”. The gained log information GLI_2 is an example of “second gained log information”.

The processing device 22e reads the control program from the memory device 24e and executes the read control program, and thereby, functions as the inquiry receiving unit 222, a gained log information transmitting unit 224e, and an accumulation unit 228.

When the identification information contained in the inquiry QU is the same as the identification information of the projector 10_1, the gained log information transmitting unit 224e transmits the gained log information GLI_1 to the projector 10 that transmitted the inquiry QU and, when the identification information contained in the inquiry QU is the same as the identification information of the projector 10_2, transmits the gained log information GLI_2 to the projector 10 that transmitted the inquiry QU. The projector 10 that transmitted the inquiry QU is an example of “first electronic apparatus”. The identification information contained in the inquiry QU is an example of “first identification information”.

The accumulation unit 228 accumulates the received log LG in the log information LI.

As described above, the log collection system 1e in the first modified example has the plurality of projectors 10. The projector 10 that transmitted the inquiry QU is represented by the first identification information. The server 20e stores a plurality of pieces of gained log information GLI representing items of the logs LG to be gained. The gained log information GLI_1 of the plurality of pieces of gained log information GLI is related to the second identification information representing one of the plurality of projectors 10. The gained log information GLI_2 included in the plurality of pieces of gained log information GLI is related to the third identification information representing one of the plurality of projectors 10. The projector 10 represented by the third identification information is different from the projector 10 represented by the second identification information. The inquiry unit 122 transmits the inquiry QU containing the first identification information to the server 20e. When the first identification information is the same as the second identification information, the gained log information transmitting unit 224e transmits the gained log information GLI_1 to the projector 10 that transmitted the inquiry QU and, when the first identification information is the same as the third identification information, transmits the gained log information GLI_2 to the projector 10 that transmitted the inquiry QU.

According to the first modified example, the server 20e may transmit the gained log information GLI_1 corresponding to the projector 10_1 to the projector 10_1 and transmit the gained log information GLI_2 corresponding to the projector 10_2 to the projector 10_2. In other words, the server 20e may change the items of the logs LG to be gained among the respective plurality of projectors 10.

Further, in other words, the log collection system 1e in the first modified example may have the following configuration. The log collection system 1e includes the projector 10_1, the projector 10_2, and the server 20e. The projector 10_1 is an example of “first electronic apparatus”. The projector 10_2 is an example of “second electronic apparatus”. The server 20e stores the gained log information GLI_1 representing the item of the log LG to be gained of the plurality of logs LG relevant to the projector 10_1 and the gained log information GLI_2 representing the item of the log LG to be gained of the plurality of logs LG relevant to the projector 10_2. The gained log information GLI_1 is an example of “third gained log information”. The gained log information GLI_2 is an example of “fourth gained log information”.

The projector 10_1 includes the inquiry unit 122, the gained log information receiving unit 124, and the transmission execution unit 126. The inquiry unit 122 included in the projector 10_1 is an example of “first inquiry unit”. The gained log information receiving unit 124 included in the projector 10_1 is an example of “first receiving unit”. The transmission execution unit 126 included in the projector 10_1 is an example of “first transmission execution unit”. The inquiry unit 122 included in the projector 10_1 transmits the first inquiry QU regarding the gained log information GLI_1 to the server 20e. The gained log information receiving unit 124 included in the projector 10_1 receives the gained log information GLI_1 transmitted from the server 20e in response to the first inquiry QU. The transmission execution unit 126 included in the projector 10_1 operates based on the gained log information GLI_1. More specifically, when the gained log information GLI_1 does not represent the first item, the transmission execution unit 126 included in the projector 10_1 does not transmit the first log LG relevant to the first item of the plurality of logs LG relevant to the projector 10_1 to the server 20e and, when the gained log information GLI_1 represents the first item, transmits the first log LG to the server 20e.

The projector 10_2 includes the inquiry unit 122, the gained log information receiving unit 124, and the transmission execution unit 126. The inquiry unit 122 included in the projector 10_2 is an example of “second inquiry unit”. The gained log information receiving unit 124 included in the projector 10_2 is an example of “second receiving unit”. The transmission execution unit 126 included in the projector 10_2 is an example of “second transmission execution unit”. The inquiry unit 122 included in the projector 10_2 transmits the second inquiry QU regarding the gained log information GLI_2 to the server 20e. The gained log information receiving unit 124 included in the projector 10_2 receives the gained log information GLI_2 transmitted from the server 20e in response to the second inquiry QU. The transmission execution unit 126 included in the projector 10_2 operates based on the gained log information GLI_2. More specifically, when the gained log information GLI_2 does not represent the second item, the transmission execution unit 126 included in the projector 10_2 does not transmit the second log LG relevant to the second item of the plurality of logs LG relevant to the projector 10_2 to the server 20e and, when the gained log information GLI_2 represents the second item, transmits the second log LG to the server 20e.

The server 20e includes the gained log information transmitting unit 224e that transmits the gained log information GLI_1 to the projector 10_1 when receiving the first inquiry QU, and transmits the gained log information GLI_2 to the projector 10_2 when receiving the second inquiry QU.

### 5.2. Second Modified Example

In the above described respective embodiments, the relating information RI contains the identification information of the projector 10, however, does not necessarily contain the identification information of the projector 10. When the relating information RI does not contain the identification information of the projector 10, the server 20 transmits the same gained log information GLI to all of the plurality of projectors 10.

### 5.3. Third Modified Example

For example, all or part of the elements realized by execution of the programs by the processing device 12 and the processing device 22 may be realized by hardware using an electronic circuit such as an FPGA (Field Programmable Gate Array) or an ASIC (Application Specific IC) or realized by cooperation of software and hardware.

### 5.4. Fourth Modified Example

The above described respective embodiments may be regarded as computer programs configured so that the above described processing devices 12 may function as the inquiry units 122, the gained log information receiving units 124, and the transmission execution units 126 or computer-readable recording media in which the computer programs are recorded. The recording media are e.g. non-transient recording media and may include any known recording media such as semiconductor recording media and magnetic recording media in addition to optical recording media such as CD-ROMs. Further, the present disclosure is specified as a control method according to the above described respective embodiments.

What is claimed is:

1. An electronic apparatus communicable with a server that stores gained log information representing an item of a log to be gained, comprising:
an inquiry unit that transmits an inquiry regarding the gained log information to the server;
a receiving unit that receives the gained log information transmitted from the server in response to the inquiry; and
a transmission execution unit that operates based on the gained log information, wherein
when the gained log information does not represent a first item, the transmission execution unit does not transmit a first log relevant to the first item of a plurality of logs relevant to the electronic apparatus to the server, and
when the gained log information represents the first item, the transmission execution unit transmits the first log to the server.

2. The electronic apparatus according to claim 1, wherein
the transmission execution unit includes:
a collection part that does not collect the first log when the gained log information does not represent the first item, and collects the first log when the gained log information represents the first item; and
a log transmission part that transmits the first log collected by the collection part to the server.

3. The electronic apparatus according to claim 1, wherein
the gained log information stored in the server is changeable based on a change instruction input to an apparatus different from the electronic apparatus.

4. A log collection system comprising:
the electronic apparatus according to claim 1; and
the server, wherein
the server includes a gained log information transmitting unit that transmits the gained log information to the electronic apparatus when receiving the inquiry.

5. The log collection system according to claim 4, comprising a plurality of electronic apparatuses, wherein
the electronic apparatus is a first electronic apparatus of the plurality of electronic apparatuses,
the first electronic apparatus is represented by first identification information,
the gained log information contains second identification information representing one of the plurality of electronic apparatuses,
the inquiry unit transmits the inquiry and the first identification information to the server, and
the gained log information transmitting unit transmits the gained log information to the first electronic apparatus when the first identification information is the same as the second identification information.

6. The log collection system according to claim 4, comprising a plurality of electronic apparatuses, wherein
the electronic apparatus is a first electronic apparatus of the plurality of electronic apparatuses,
the first electronic apparatus is represented by first identification information,
the server stores a plurality of pieces of gained log information representing items of logs to be gained,
the gained log information is first gained log information of the plurality of pieces of gained log information,
the first gained log information is related to second identification information representing one of the plurality of electronic apparatuses,
second gained log information contained in the plurality of pieces of gained log information is related to third identification information representing one of the plurality of electronic apparatuses,
the electronic apparatus represented by the third identification information is different from the electronic apparatus represented by the second identification information,
the inquiry unit transmits the inquiry containing the first identification information to the server,
the gained log information transmitting unit transmits the first gained log information to the first electronic apparatus when the first identification information is the same as the second identification information, and
the gained log information transmitting unit transmits the second gained log information to the first electronic apparatus when the first identification information is the same as the third identification information.

7. The log collection system according to claim 4, wherein
the gained log information stored in the server is version-upgradable,
the server stores first version information representing a version of the gained log information,
the transmission execution unit transmits the first log and second version information representing a version of the gained log information to the server,
the gained log information transmitting unit transmits the gained log information and the first version information stored in the server to the electronic apparatus when the first version information and the second version information are different.

8. A log collection system comprising:
a first electronic apparatus;
a second electronic apparatus; and
a server, wherein
the server stores third gained log information representing an item of a log to be gained of a plurality of logs relevant to the first electronic apparatus and fourth gained log information representing an item of a log to be gained of a plurality of logs relevant to the second electronic apparatus,
the first electronic apparatus includes
a first inquiry unit that transmits a first inquiry regarding the third gained log information to the server,
a first receiving unit that receives the third gained log information transmitted from the server in response to the first inquiry, and
a first transmission execution unit that operates based on the third gained log information,
when the third gained log information does not represent a first item, the first transmission execution unit does not transmit a first log relevant to the first item of the plurality of logs relevant to the first electronic apparatus to the server, and
when the third gained log information represents the first item, the first transmission execution unit transmits the first log to the server,
the second electronic apparatus includes
a second inquiry unit that transmits a second inquiry regarding the fourth gained log information to the server,
a second receiving unit that receives the fourth gained log information transmitted from the server in response to the second inquiry, and
a second transmission execution unit that operates based on the fourth gained log information,
when the fourth gained log information does not represent a second item, the second transmission execution unit does not transmit a second log relevant to the second item of the plurality of logs relevant to the second electronic apparatus to the server, and,
when the fourth gained log information represents the second item, the second transmission execution unit transmits the second log to the server, and
the server includes a gained log information transmitting unit that transmits the third gained log information to the first electronic apparatus when receiving the first inquiry, and transmits the fourth gained log information to the second electronic apparatus when receiving the second inquiry.

9. A control method for an electronic apparatus communicable with a server that stores gained log information representing an item of a log to be gained, comprising:
transmitting an inquiry regarding the gained log information to the server;
receiving the gained log information transmitted from the server in response to the inquiry; and
not transmitting a first log relevant to the first item of a plurality of logs relevant to the electronic apparatus to the server when the gained log information does not represent a first item and, transmitting the first log to the server when the gained log information represents the first item.
